(19) United States
(12) Patent Application Publication
(10) Pub. No.: US 2013/0125108 A1
(43) Pub. Date: May 16, 2013

(54) SYSTEM AND METHOD FOR UPGRADING FIRMWARE

(71) Applicants: Rajesh Bhimrao Pawar, Mumbai (IN); Saurabh Anil Jogdand, Pune (IN)

(72) Inventors: Rajesh Bhimrao Pawar, Mumbai (IN); Saurabh Anil Jogdand, Pune (IN)

(73) Assignee: General Electric Company, Schenectady, NY (US)

(21) Appl. No.: 13/298,271

(22) Filed: Nov. 16, 2011

(51) Int. Cl. G06F 9/44

(52) U.S. Cl. 717/171

(57) ABSTRACT

In an embodiment, a firmware upgrading system includes a device having a first memory configured to store a firmware, wherein the firmware includes a set of instructions that control the operation of the device. The system also includes a first processor configured to execute the firmware. The system also includes a first capacitively coupled (CC) communication module configured to enable the device communicate with a device reader, and the device is configured to receive upgraded firmware via the CC communication module. In another embodiment, a non-transitory, computer-readable medium storing instructions executable by a processor of an electronic device, including instructions to receive a selection of a file from a user interface, wherein the file comprises an upgraded firmware for a probe. The medium also includes instructions to send the upgraded firmware from the selected file to the probe via a capacitively coupled (CC) communication link.

The subject matter disclosed herein relates to firmware upgrades for electronic devices, such as sensing probes.

Sensing probes are widely used in various medical, pharmaceutical, and food processing applications to assess certain parameters (e.g., pressure, temperature, humidity, etc.) of particular processes. In particular, certain process monitoring probes may be exposed to hostile environments (e.g., high pressure and temperature or cryogenic temperatures) and, as such, these probes may be sealed to protect the internal components. The use of traditional probe wires or ports may not be feasible for these types of sealed probes and, therefore, wireless communication may be used to retrieve sensing data collected by the probes.

In order to upgrade the firmware of such a sealed probe, the probe may be shipped back to the manufacturer, disassembled, and the internal components of the probe may be electronically upgraded (or physically replaced). Subsequently, the probe may be reassembled, sealed, and returned to the customer. In addition to the actual cost of the upgrade, the turn-around-time for this process may be approximately 1-4 months, and the customer may have to obtain and use a replacement probe in the interim. Furthermore, the shipping, disassembly, and reassembly steps each introduce opportunities for the more delicate internals of the probe to be damaged, potentially introducing further cost.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In an embodiment, a device firmware upgrading system includes a device having a first memory configured to store a firmware, wherein the firmware includes a set of instructions that control the operation of the device. The system also includes a first processor configured to execute the firmware. The system also includes a first capacitively coupled (CC) communication module configured to enable the device communicate with a device reader, and the device is configured to receive an upgraded firmware via the CC communication module.

In another embodiment, a method for probe firmware upgrading includes storing a first firmware in a memory of a probe, wherein the first firmware includes a first set of instructions to control the operation of the probe. The method also includes receiving a second firmware via a capacitively coupled (CC) communication module of the probe, wherein the second firmware comprises a second set of instructions to control the operation of the probe. The method also includes storing the second firmware in the memory of the probe.

In another embodiment, a non-transitory, computer-readable medium storing instructions executable by a processor of an electronic device, including instructions to receive a selection of a file from a user interface, wherein the file comprises an upgraded firmware for a probe. The medium also includes instructions to send the upgraded firmware from the selected file to the probe via a capacitively coupled (CC) communication link.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a perspective view illustrating an embodiment of a system having a probe, a probe reader, and a computer;

FIG. 2 is a schematic view illustrating an embodiment of a probe firmware upgrading system;

FIG. 3 is a screen-shot of an embodiment of the firmware upgrade tool user interface;

FIG. 4 is another screen-shot of an embodiment of the firmware upgrade tool user interface;

FIG. 5 is a flow diagram illustrating an embodiment of a process by which the firmware upgrade tool upgrades the firmware of the probe;

FIG. 6 is a flow diagram illustrating an embodiment of a process by which the probe is queried and responds regarding the version of the firmware currently installed on the probe; and

FIG. 7 is a flow diagram illustrating an embodiment of a process by which the probe upgrades its firmware.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments are generally directed towards sensing probes for process applications that utilize capacitively coupled (CC) communication to receive firmware upgrades. For example, the disclosed probe embodiments may utilize CC communication links to exchange both collected sensing data and firmware upgrades with a sensor reader. It should be noted that, in the context of the present application, the term “upgrade” refers to upgrading, updating, or otherwise changing the firmware installed on a probe to any other version of the firmware, including previous versions (e.g., a roll-back). It should also be appreciated that while the present firmware update is discussed in the context of a firmware upgrade for a probe or sensing device, the disclosed techniques may be applied to any electronic device using CC communication (e.g., a controller, smart phone, tablet, or similar device).

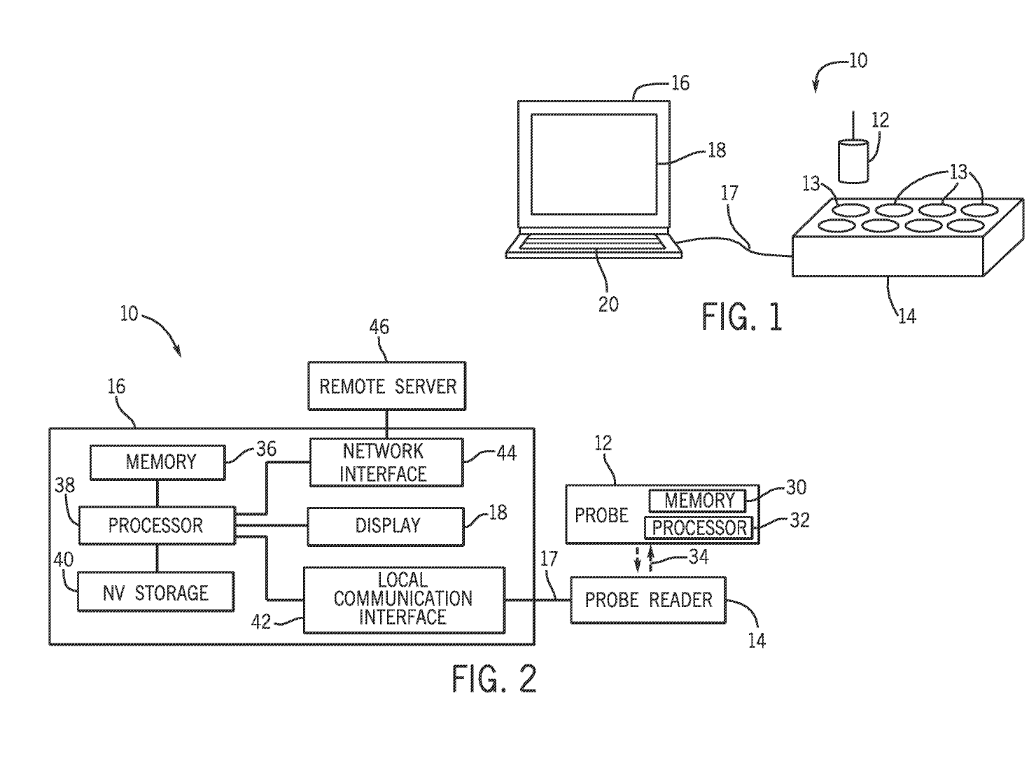

With the foregoing in mind, FIG. 1 illustrates a perspective view of an embodiment of a probe firmware upgrading system 10. In particular, the probe firmware upgrading system 10 illustrated in FIG. 1 includes a probe 12, a probe reader 14, and a computer 16. Generally speaking, the probe 12 may be a probe for process monitoring and/or validation that is capable of measuring temperature, pressure, humidity, flow rates, turbulence, acceleration, voltage, current, or similar parameters. For example, the probe 12 may be a modified version of the Kaye Valprobe® Cyro Temperature Logger, available from General Electric (GE) Inc. By further example, the probe 12 may be a probe as described in the U.S. Pat. No. 6,836,220, filed Aug. 3, 2001, which is incorporated by reference in its entirety for all purposes.

In certain embodiments, the probe 12 may be designed for operation in harsh environments and, therefore, may be sealed such that the environment external to the probe may have limited effects on the internals of the probe. For example, while taking measurements the probe 12 may be placed within any unit (e.g., autoclave, freezer, oven, EtO sterilization chamber, etc.), reactor (e.g., combustion reactor, gasification reactor, gas treatment reactor, etc.), conduit (e.g., a pipe, channel, or vent), or piece of equipment (e.g., turbine, compressor, air separation units). Indeed, the probe 12 may be located at any point within a manufacturing process or location used for the production of pharmaceuticals or other consumer products. Accordingly, in certain embodiments, the probe 12 may lack external ports or windows to enable common forms of wired or optical communication. As such, certain embodiments of the probe 12 may exclusively rely on CC communication to connect to the probe reader 14, such that the sensing data may be delivered and upgraded firmware may be received, as discussed below. Additionally, in certain embodiments, the probe 12 may rely on a combination of CC communication and other forms of wireless communication (e.g., RF or optical communication) to communicatively couple to the probe reader 14.

Generally speaking, to engage in CC communication with the probe reader 14, the probe 12 may include conductive base and cap sections that are sealed together by an insulating gasket. When loaded into the probe reader 14, the probe 12 is may capacitively couple the conductive base section of the probe 12 to the inner wall of the socket 13 of the probe reader 14. The probe 12 may also establish a radio-frequency ground connection about the cap section of the probe 12, which may protrude from the socket 13 when the probe 12 is loaded into the probe reader 14. Accordingly, a radio-frequency communication path is created through the capacitive coupling of the probe 12 to the walls of the socket 13 of the probe reader 14.

Accordingly, the probe reader 14 is equipped with a communication module that is configured to communicate with the probe 12 in a capacitively coupled (CC) manner. The probe reader 14 may be equipped with any number of sockets 13 (e.g., between 1 and 10, 1 and 20, or 1 and 50), and each socket 13 may be capable of establishing an independent CC communication channel to a probe 12 loaded the respective socket 13. Furthermore, the probe reader 14 is equipped with a communication interface that allows the probe reader 14 to be coupled to the computer 16. For example, in certain embodiments, the probe reader 14 and computer 16 may be equipped with a wired interface (e.g., USB, IEEE1394, serial port, parallel port, or similar wired interface) for coupling the probe reader 14 to the appropriate port of the computer 16 via a cable 17. In other embodiments, the probe reader 14 and the computer 16 may be equipped with a wireless interface (e.g., 802.11, Bluetooth, ZigBee, WirelessHART, MiWi, ultra-wideband (UWB), near-field communication (NFC), or similar wireless interface) for coupling the probe reader 14 to the computer 16.

The computer 16 of the illustrated probe firmware upgrading system 10 may be a laptop or desktop computer platform. In certain embodiments, the computer 16 may be a smart-phone, tablet, PDA, or similar computing device. As such, the computer 16 may be equipped with a display 18 (e.g., a cathode-ray tube (CRT), liquid-crystal display (LCD), touchscreen or the like) capable of presenting a user with information and selection options regarding the firmware upgrade process discussed in detail below. In certain embodiments, the computer 16 may also be equipped with a printer, a speaker, indicator lights, or other similar output devices. Additionally, the computer 16 may also be equipped with various user input devices 20 (e.g., a keyboard, mouse, touchpad, touchscreen, voice control device, gesture control device, or other input device) that may allow a user to select and/or input parameters regarding the firmware upgrade process presented below.

Turning to FIG. 2, a schematic of the probe firmware upgrading system 10 is illustrated. More specifically, FIG. 2 illustrates certain components of the probe 12, the probe reader 14, and the computer 16. The probe 12 illustrated in FIG. 2 includes both a memory 30 and a processor 32. Generally speaking, the processor 32 controls the operation of the probe through the execution of the probe's firmware, which may be stored in the memory 30 of the probe 12. The probe 12, when loaded in a socket of the probe reader 14, may be communicatively coupled to the probe reader 14 via the CC communication link 34 such that sensing data may be retrieved from the probe 12, instructions may be sent to the probe 12, and upgraded firmware may be sent to the probe 12 by the computer 16 via the probe reader 14.

The computer 16 illustrated in FIG. 2 includes memory 36, a processor 38, nonvolatile storage 40, and other computer components. Additionally, as mentioned, the computer 16 includes a local communication interface 42 that is capable of communicatively coupling the computer 16 to the probe reader 14 via a cable 17 or a wireless connection. Furthermore, in certain embodiments, the computer 16 may include a network interface 44 that is capable of communicatively coupling the computer 16 to a remote server 46. For example, in certain embodiments, the computer 16 may include a wired or wireless network interface 44 (e.g., a network interface card, a modem, or similar communication interface) such that the computer 16 may request and receive a file containing and upgraded firmware for the probe from the remote server 46 (e.g., a server hosted by the manufacturer).

Accordingly, the probe firmware upgrading system 10 includes a firmware upgrade tool. For example, the firmware upgrade tool may include a set of instructions executed by the processor 38 of the computer 16, and/or the processor 32 of the probe 12, in order to provide the firmware upgrade of the probe 12. This firmware upgrade tool may include a user interface so that a user may control the parameters of the probe firmware upgrade. That is, the computer 16 may utilize the display 18, in combination with the user inputs 20, to present a user interface to the user so that the user may view and/or alter settings pertaining to the firmware upgrade.

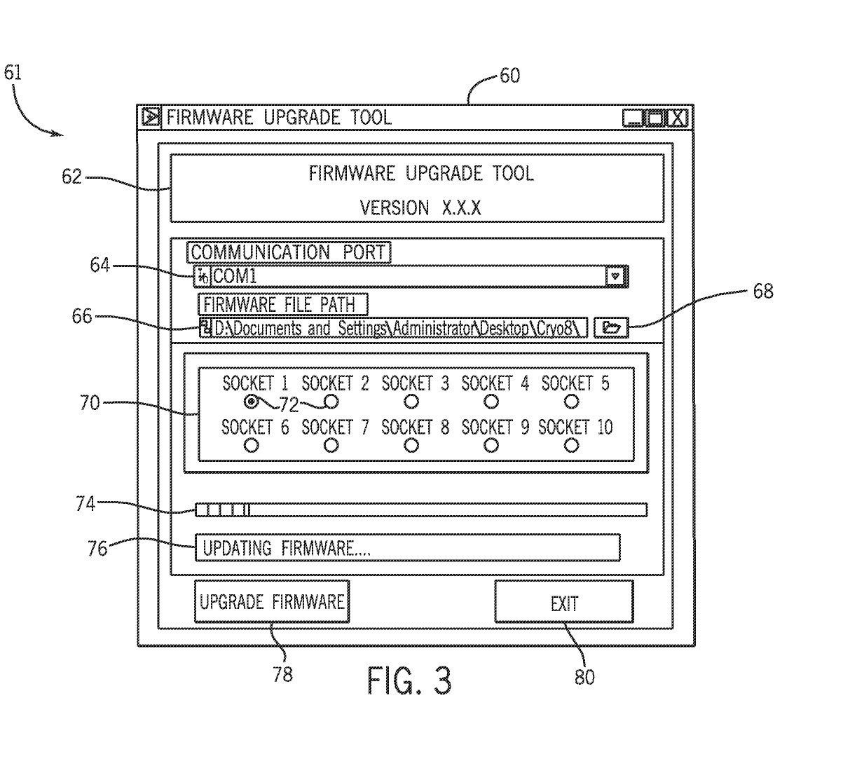

For example, turning to FIG. 3, a screen-shot of an embodiment of the user interface 60 of the firmware upgrade tool 61 is illustrated. The illustrated user interface 60 includes a title portion 62 which may display the identity and version of the firmware upgrade tool 61 being executed. Additionally, the illustrated user interface 60 includes a user input 64 (e.g., a select or combo box, text box, a set of radio buttons or checkboxes, or similar user input mechanism) to allow the user to select a communication interface of the computer 16 to which the probe reader 14 is coupled. For example, the user input 64 may be a combo box populated with communication interfaces present on the computer 16 (e.g., “COM1”, “COM2”, “LPT1”, etc.). In certain embodiments, the list of communication interfaces may include logical and/or physical communication ports or channels to the computer 16.

Furthermore, the illustrated user interface 60 includes another user input 66 to allow the user to select a file containing an upgraded firmware for the probe 12. For example, the user input 66 may be a select or combo box, a text box, or similar input mechanism by which a user may select or enter the path and/or filename to identify a local file containing the upgraded firmware. Furthermore, in certain embodiments, the user input 66 may also include a button 68 that may allow the user to navigate the local file system (e.g., using a file browser or manager) to identify the path and/or filename of the file storing the upgraded firmware. In certain embodiments, once a user has identified a local file using the user input 66 and/or 68, the firmware upgrade tool 61 may perform one or more validations of the identified file (e.g., verifying the file name, specific contents of the file, a checksum or hash of the file, or similar file validation technique) to ensure that the identified file includes the upgraded firmware for the probe 12.

Additionally, the illustrated user interface 60 includes a user input 70 having a number of radio buttons 72. Each of the illustrated radio buttons 72 of the user inputs 70 identifies one of the sockets 13 of the probe reader 14. The radio buttons 72 of the user input 70 allow the user to select the socket 13 in which the probe 12 is loaded. In certain embodiments, only one radio button 72, representing a single socket 13, may be selected for the firmware upgrade process. In other embodiments, the user inputs 70 may be implemented as a collection of checkboxes that allow multiple sockets (and therefore multiple probes) to be upgraded simultaneously. Additionally, in other embodiments, the probe reader 14 may detect which socket(s) have probes loaded, and the user inputs 70 of the user interface 60 may display these sockets selected.

Furthermore, the illustrated user interface 60 includes a progress bar 74 and a notification area 76 to inform the user of the status of the firmware upgrade process. For example, the progress bar 74 may be used to illustrate the progress of the entire firmware upgrade process, or any portion thereof (e.g., the progress of transferring the upgraded firmware to the probe). By further example, the notification area 76 may be used to inform the user of the current state of the firmware upgrade tool 61 (e.g., “Updating firmware”, “Transferring firmware”, “Transfer complete”, “Waiting for probe to restart”, or similar message). Furthermore, the progress bar 74 and/or notification area 76 may be used to inform the user that an error has occurred during the firmware upgrade process. For example, if in error has occurred during the transfer of the firmware to the probe, the progress bar 74 may alter its appearance from green to red and the notification area 76 may include the message, “An error has occurred when transferring the firmware to the probe.”

Also, the illustrated user interface 60 includes an “Upgrade Firmware” button 78 and an “Exit” or “Cancel” button 80. Once the user has completed setting the user inputs (e.g., user inputs 64, 66, and 70) of the user interface 60 to set the parameters of the upgrade, the user may select the “Upgrade Firmware” button 78 to begin the firmware upgrade process. Alternatively, the user may abort the upgrade process and/or close the firmware upgrade tool 61 by selecting the “Exit” button 80.

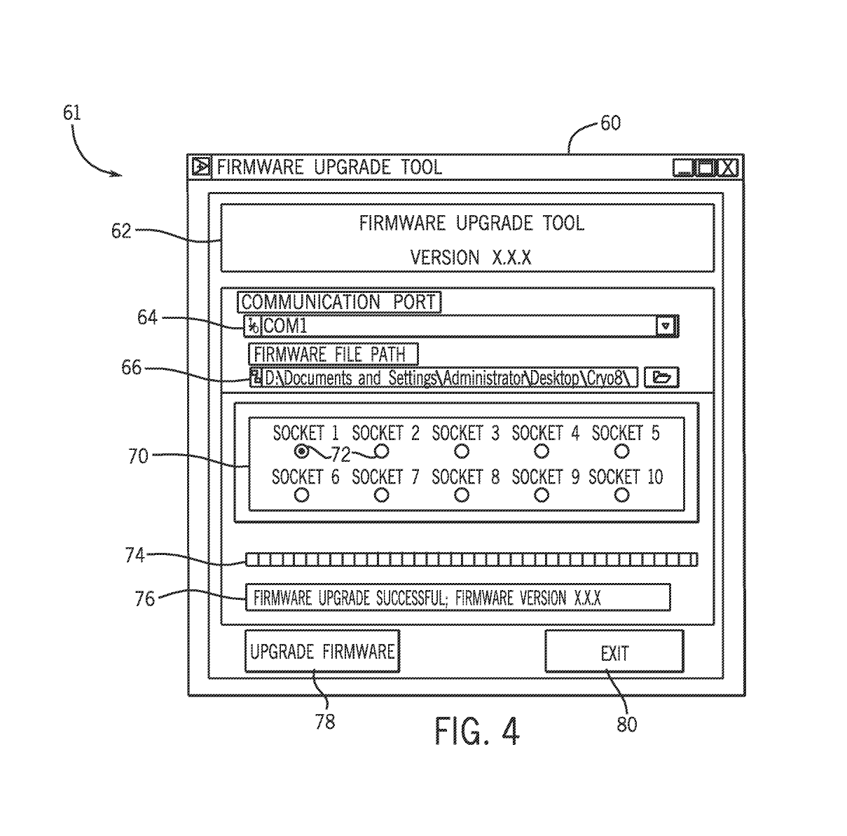

Turning now to FIG. 4, a screen-shot of the user interface 60 is illustrated at a different point in the firmware upgrade process. That is, the user interface 60 illustrated in FIG. 4 depicts an embodiment of the user interface 60 when the firmware upgrade process of a probe has been successfully completed. As such, the illustrated progress bar 74 completely spans its length, representing 100% percent completion of the firmware upgrade process. Additionally, the notification area 76 includes the message, “Firmware upgrade successful.” Furthermore, in the illustrated embodiment, the notification area 76 includes information regarding the current firmware version installed on the probe once the upgrade process is complete (e.g., “Firmware version X.X.X”).

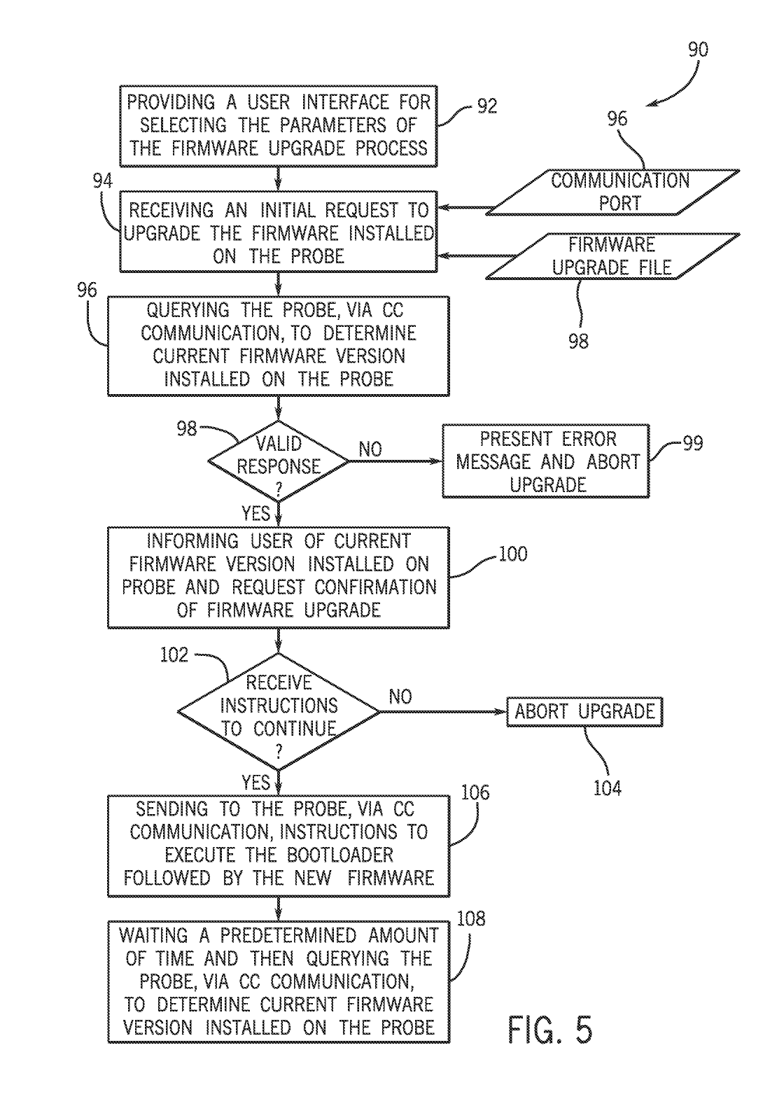

Turning to FIG. 5, a flow diagram is presented that illustrates an embodiment of a process 90 (e.g., executed by processor 38 of the computer 16) by which the firmware upgrade tool 61 upgrades the firmware of the probe 12. The process begins with the firmware upgrade tool 61 providing (block 92) a user interface (e.g., user interface 60) for selecting the parameters of the firmware upgrade process. After presenting the user interface to the user, the user may use the user inputs (e.g., user inputs 64, 66, and 70) to select the various parameters of the upgrade process, followed by selecting the “Upgrade Firmware” button 78. Subsequently, the firmware upgrade tool 61 receives (block 94) the initial request to upgrade the firmware installed on the probe according to the parameters (e.g., the communication port 96 and firmware upgrade file 98) selected by the user. The firmware upgrade tool 61 may query (block 96) the probe, via the CC communication link 34, to determine the current firmware version installed on the probe. In certain embodiments, the firmware upgrade tool 61 may instead automatically perform this query when a probe 12 is loaded into the probe reader 14 or when the firmware upgrade tool 61 is first opened. Additionally, in certain embodiments, the firmware upgrade tool 61 may include an option to manually query a probe to determine the current version of the firmware on the probe 12.

Regardless of when the probe is queried, the firmware upgrade tool 61 analyzes the response from the probe to determine if it is valid (block 98). For example, if the firmware upgrade tool 61 is unable to communicate with the probe, then the firmware upgrade tool 61 may not receive a valid response from the probe. Furthermore, even if the firmware upgrade tool 61 is communicatively coupled to the probe, the response received from the probe may not be valid in the context of the present firmware upgrade request. For example, if the probe informs the firmware upgrade tool 61 that the current version of the firmware installed on the probe 12 is newer than the firmware stored in the firmware upgrade file 98, then the firmware upgrade tool 61 may determine that the response is not valid unless another condition is met (e.g., a ignore-version or force-install option is selected). As such, the firmware upgrade tool 61 may present (block 99) an error message to the user (e.g., via notification area 76 or a separate pop-up error window in the user interface) and abort the upgrade process.

However, if the firmware upgrade tool 61 determines that the parameters (e.g., parameters 96 and 98) provided by the user are valid with respect to the current firmware installed on the probe, then the firmware upgrade tool 61 may include a confirmation step. That is, the firmware upgrade tool 61 may inform (block 100) the user of the current firmware version installed on the probe, inform the user of the parameters selected, and request confirmation that the user wants to continue with the upgrade process. In certain embodiments, this information may be presented the form of a pop-up box or in the notification area 76 of the user interface 60. The firmware upgrade tool 61 may subsequently wait to receive (block 102) instructions to continue. If the user does not select the option to continue the upgrade process, the upgrade process may be aborted (block 104), and the user may be notified accordingly. It should be noted that, in certain embodiments of the process, the confirmation step illustrated in blocks 100 and 102 may not be included.

Once the firmware upgrade tool 61 has received instructions to proceed, the firmware upgrade tool 61 may send (block 106) instructions to the probe, via the CC communication link 34, to execute the bootloader portion of the current firmware installed on the probe. In certain embodiments, after sending these instructions, the firmware upgrade tool 61 may immediately begin transferring the firmware to the probe via the CC communication link 34. In other embodiments, the firmware upgrade tool 61 may wait to receive a request from the bootloader portion of the current firmware installed on the probe to begin the transfer process.

Once the firmware has been transferred to the probe, the firmware upgrade tool 61 may wait (block 108) a predetermined amount of time before querying the probe, via the CC communication link 34, to determine the current firmware version installed on the probe. For example, after the firmware has been transferred to the probe 12, the firmware upgrade tool 61 may wait 30 seconds, 1 minute, 2 minutes, or 5 minutes to allow the probe adequate time to write the firmware to memory and to reboot before querying the probe. In other embodiments, after the new firmware has been installed on the probe and the probe reboots, the probe may contact the firmware upgrade tool 61 to inform the tool of the new version of the firmware installed on the probe.

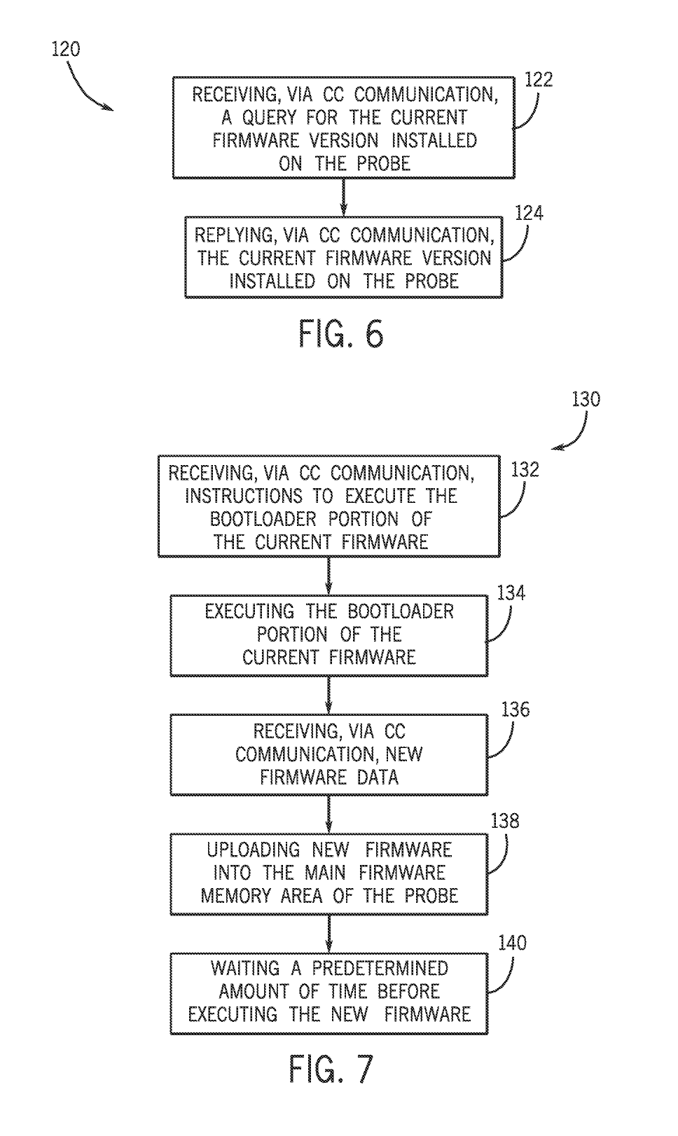

As mentioned with respect to block 96 of FIG. 5, the firmware upgrade tool 61 may query the probe via the CC communication link 34 to determine the current version of the firmware installed on the probe. Turning to FIG. 6, the firmware version query process 120 is illustrated from the perspective of the probe 12. The process 120 begins with the probe receiving (block 122), via the CC communication link 34, a query for the current firmware version installed on the probe. In certain embodiments, the current version of the firmware installed may be stored in a portion of the memory 30 of the probe 12. Accordingly, the probe may reply (block 124), via the CC communication link 34, the current firmware version installed on the probe 12.

Furthermore, as mentioned with respect to block 106 of FIG. 5, the firmware upgrade tool 61 may send the probe 12 instructions to execute the bootloader portion of the current firmware before sending the new firmware to the probe 12. Turning to FIG. 7, the firmware transfer process 130 is illustrated from the perspective of the probe 12. As such, the process 130 begins with the probe 12 receiving (block 132), via the CC communication link 34, instructions to execute the bootloader portion of the current firmware. Subsequently, the probe 12 begins executing (block 134) the bootloader portion of the current firmware. The probe 12, now executing the bootloader portion, receives (block 136), via the CC communication link 34, the new firmware data. After receiving the new firmware data, the probe 12 may upload (block 138) the new firmware into the main portion of the memory 30 of the probe 12. Once the new firmware data has been written into the main memory area of the probe, the probe 12 may wait (block 140) a predetermined amount of time before executing the new firmware. In certain embodiments, the probe 12 may execute the new firmware immediately after uploading it to the main memory area of the probe.

Technical effects of the invention include utilizing capacitively coupled (CC) communication to install firmware upgrades on devices, such as sealed probes (e.g., temperature, pressure, or humidity probes). By using CC communication links to install firmware upgrades, the devices need not be sent to the manufacturer and disassembled/reassembled in order to upgrade the firmware of the device. This may allow for the correction of mistakes present in the original firmware installed on the device as well as the addition of new features absent from the original firmware at drastically reduced cost to both the customer and manufacturer. Furthermore, presently disclosed firmware upgrade process may be completed in a matter of minutes compared to the 1-4 months typically required for a manufacturer to receive, disassemble, upgrade, reassemble, and resend the device to the customer. As such, the presently disclosed firmware upgrade process significantly improves the turnaround time, cost, and efficiency of device firmware upgrades.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A device firmware upgrading system comprising:
a device comprising:
a first memory configured to store a firmware, wherein the firmware comprises a set of instructions that control the operation of the device,
a first processor configured to execute the firmware, and
a first capacitively coupled (CC) communication module configured to enable the device communicate with a device reader;
wherein the device is configured to receive an upgraded firmware via the CC communication module.

2. The system of claim 1, wherein the device comprises a sensor or a probe.

3. The system of claim 1, wherein the device is configured to store the upgraded firmware in the first memory and execute the upgraded firmware with the first processor.

4. The system of claim 1, comprising a device reader, wherein the device reader comprises a second CC communication module that is configured to communicatively couple to the first CC communication module of the device.

5. The system of claim 4, wherein the device reader is configured to send the upgraded firmware to the device.

6. The system of claim 4, wherein the device reader comprises a first computer communication module configured to communicatively couple the device reader to a computer.

7. The system of claim 4, wherein the device reader is configured to request and receive information stored in the first memory of the device.

8. The system of claim 4, comprising a computer comprising:
a second computer communication module configured to communicatively couple to the first computer communication module of the device reader;
a second memory configured to store the upgraded firmware; and
a second processor configured to instruct the device reader to send the upgraded firmware stored in the second memory to the device.

9. The system of claim 8, wherein the computer comprises a user interface executed by the second processor and configured allow a user to select the upgraded firmware and the communication interface of the device reader.

10. The system of claim 9, wherein the user interface is configured to inform the user that the device has received, stored, and executed the upgraded firmware.

11. A method for probe firmware upgrading comprising:
storing a first firmware in a memory of a probe, wherein the first firmware comprises a first set of instructions to control the operation of the probe;
receiving a second firmware via a capacitively coupled (CC) communication module of the probe, wherein the second firmware comprises a second set of instructions to control the operation of the probe;
storing the second firmware in the memory of the probe.

12. The method of claim 11, comprising executing, via a processor of the probe, the first or second firmware stored in the memory of the probe.

13. The method of claim 11, comprising
receiving, via the CC communication module of the probe, a query for a version of the first or second firmware stored in the memory of the probe; and
replying to the query, via the CC communication module of the probe, with a response having the version of the first or second firmware stored in the memory of the probe.

14. The method of claim 11, comprising receiving instructions, via the CC communication module of the probe, to execute a bootloader portion of the first firmware.

15. The method of claim 13, comprising executing, via a processor of the probe, the bootloader portion of the first firmware.

16. A non-transitory, computer-readable medium storing instructions executable by a processor of an electronic device, comprising:
instructions to receive a selection of a file from a user interface, wherein the file comprises an upgraded firmware for a probe; and
instructions to send the upgraded firmware from the selected file to the probe via a capacitively coupled (CC) communication link.

17. The non-transitory, computer-readable medium of claim 16, comprising instructions to display the user interface, wherein the user interface comprises inputs to enable selection of the file, inputs to enable selection of a communication port coupled to a probe reader, inputs to enable the selection of a socket of a probe reader, or any combination thereof.

18. The non-transitory, computer-readable medium of claim 16, comprising instruction to send instructions to the probe, via the CC communication link, to execute a bootloader portion of a firmware installed on the probe.

19. The non-transitory, computer-readable medium of claim 16, comprising instructions to query the probe, via the CC communication link, to determine a version of a firmware installed on the probe prior to sending the upgraded firmware to the probe.

20. The non-transitory, computer-readable medium of claim 16, comprising instructions to query the probe, via the CC communication link, to determine a version of a firmware installed on the probe after sending the upgraded firmware to the probe.
